(19) United States
(12) Patent Application Publication
(10) Pub. No.: US 2011/0122839 A1
(43) Pub. Date: May 26, 2011

(54) Inter-bss packet-switched handover

(76) Inventors: Vlora Rexhepi, Espoo (FI); Shkumbin Hamiti, Espoo (FI)

(21) Appl. No.: 11/660,464

(22) PCT Filed: Aug. 8, 2005
(86) PCT No.: PCT/IB05/02598

§ 371 Date: Sep. 19, 2007

(30) Foreign Application Priority Data
Aug. 18, 2004 (GB) 0418436.2

(51) Int. Cl. H04W 36/00

(52) U.S. Cl. 370/331

(57) ABSTRACT

A mobile communication system of packet switched handover in GERAN A/Gb mode, the handover comprising: means for transmitting an exchange identification command to a mobile station for any created packet flow context prior to connection of the mobile station in a target cell.

### BACKGROUND TO THE INVENTION

1. Field of the Invention

The invention relates to packet switched handover in GERAN A/Gb mode in a mobile communication system.

2. Description of the Related Art

A mobile communication system is an example of a system in which an access network is provided to allow access to the system functionality for user terminals.

A radio access network typically provides access for user equipment to a mobile communications system core network. The user equipment typically communicates with the access network over a radio interface, the access network including a plurality of network access points, with which the user equipment establishes a connection. Each of the network access points is connected to one or more network access controllers.

Packet switched (PS) handover in GERAN A/Gb mode is currently being defined through standardisation in TSG GERAN2, and current proposals are discussed in 3GPP TS 43.129 VO.6.0.

The mechanism for the transfer of the ‘XiD [eXchange IDentification] Command’ has not been defined yet in the standardisation. This mechanism has, however, been indicated in several technical documents and discussed in the TSG GERAN 2 meetings. Example discussion documentation includes G2-040378, G2-040445, G2-040390, GP-041557, GP-041424, GP-041510, and GP-041562.

The XID and Layer 3 parameters in GERAN A/Gb mode are described in TS44.064. As specified, the XID command/response frame is used to negotiate and re-negotiate the LLC (logical link control) layer parameters and layer 3 parameters. XID frames can be transmitted in LLC unacknowledged (ADM) and acknowledged mode (ABM). The Layer 3 parameters, i.e. SNDCP XID parameters, are defined in TS44.065.

Further the exchange of the ROHC parameters is defined in the TS44.065 and in TS25.331, TS29.060.

One solution for the exchange of the XiD command, presented in GP-041424, suggests sending the XiD command from a new SGSN (serving GPRS support node) to a target BSS (base station subsystem) in a PS (packet switched) Handover Request message. In this proposal the target BSS includes this message, i.e. a so-called core network (CN) to mobile Station (MS) container, without processing it, in the transparent container to be sent to the MS. An advantage for this solution is that it has a low impact on the specified procedures, and follows the current principle that the target side prepares the handover command for the source side, which then needs to forward this further to the mobile station.

However this solution leads to a problem of sending an amount of unnecessary information over the air interface, resulting in a waste of radio resources as well as a large packet switched handover command message.

It is an aim of the invention to provide an improved technique for the exchange of exchange identification command or parameters in packet switched handover in GERAN A/Gb B mode.

### SUMMARY OF THE INVENTION:

The invention provides a method of packet switched handover in GERAN A/Gb mode, which method comprises transferring an exchange identification command between a target serving GPRS support node, SGSN, and a target base station subsystem, BSS, only for those packet flow contexts which are accepted during the packet switched handover preparation phase.

The method may further comprise the step of determining at the target BSS resources for handover, which step includes determining acceptance of packet flow contexts. The packet flow contexts may be accepted in dependence on the allocation of radio resources thereto. The method may further comprise transferring said exchange identification command to a mobile station subject to the handover. The exchange command may be created before transmission of a handover request message. The exchange command may be created upon receipt of a handover request response message.

The invention provides a method of packet switched handover in GERAN A/Gb mode, the handover including the steps of: receiving a handover request at a target base station subsystem, BSS; determining, at the target BSS, accepted packet flow contexts; notifying the accepted packet flow contexts to the target SGSN; receiving an exchange identification command for the accepted packet flow contexts at the target BSS: and receiving a handover request response at the target SGSN, said response including the exchange identification command for the setup flow control contexts.

The handover request may be transmitted from the target SGSN to the target BSS responsive to receipt of a relocation request at the target SGSN.

The handover request may be received at the target BSS includes an exchange identification command indicator.

Responsive to the exchange identification command indicator being set, the accepted packet flow contexts may be determined.

The step of determining the accepted packet flow contexts may include allocating resources to one or more packet flow contexts downloaded from the target SGSN.

Responsive to the step for determining the accepted packet flow contexts, the target BSS may allocate a transport block flow for each transport flow context.

The notification of the accepted packet flow contexts may include the identity of those packet flow contexts setup, and/or those packet flow contexts which have failed to be setup.

The step of receiving the exchange identification command for the accepted packet flow contexts at the target BSS may comprise including said command in a packet switched handover BSS PFC status report acknowledgement message at the target SGSN.

The invention provides a method of packet switched handover in GERAN A/Gb mode, the handover including the steps of: responsive to receipt of a relocation request at a target SGSN, transmitting a request for packet flow contexts to a target base station subsystem, BSS; determining, at the target BSS, accepted packet flow contexts; transmitting details of the accepted packet flow contexts to the target SGSN; transmitting a handover request, including an exchange identification command for the accepted packet flow contexts, to the target BSS: and transmitting a handover request response to the target SGSN, said response including the exchange identification command for the setup flow control contexts.

The relocation request may comprise a forward relocation request message.

The step of transmitting a request for packet flow contexts to the target BSS may include initiating a BSS PFC create procedure at the target BSS.

The transmitting of a request for packet flow contexts to the target BSS may include an indicator that the BSS PFC is subject to handover. The indicator may be included in an information element.

The method may comprise the step of reserving radio resources for one or more packet flow contexts downloaded from the target SGSN.

The method may comprise allocating, at the target BSS, transport block flows for each accommodated packet flow context.

The method may further include the step of creating a corresponding BSS PFC.

The transmitting of details of the accepted packet flow contexts from the target BSS to the target SGSN may include transmitting a create BSS PFC Ack/NAck message.

The handover request may include an exchange identification command only for the accepted packet flow contexts.

The handover request response may include the exchange identification command only for the setup flow control contexts.

The invention provides a method of packet switched handover in GERAN A/Gb mode, the handover comprising the steps of: transmitting an exchange identification command to a mobile station for any created packet flow context prior to connection of the mobile station in a target cell.

The invention provides a mobile communication system adapted for packet switched handover in GERAN A/Gb mode, said system comprising, during handover, a target serving GPRS support node, SGSN, and a target base station subsystem, BSS, in which system the transfer of an exchange identification command between the target SGSN and the BSS is only for those packet flow contexts which are accepted during the packet switched handover preparation phase.

The target BSS may be adapted to determine resources for handover, in dependence on which the acceptance of packet flow contexts is determined. The packet flow contexts may be accepted in dependence on the allocation of radio resources thereto. Said exchange identification command may be transferred to a mobile station subject to the handover. The exchange command may be created before transmission of a handover request message. The exchange command may be created upon receipt of a handover request response message.

The invention provides a mobile communication system adapted for packet switched handover in GERAN A/Gb mode, the system including a target base station subsystem, BSS, and a target serving GPRS support node, SGSN, the system further including: means for receiving a handover request at the target BSS; means for determining, at the target BSS, accepted packet flow contexts; means for notifying the accepted packet flow contexts to the target SGSN; means for receiving an exchange identification command for the accepted packet flow contexts at the target BSS: and means for receiving a handover request response at the target SGSN, said response including the exchange identification command for the setup flow control contexts.

The mobile communication system may further include means for transmitting the handover request from the target SGSN to the target BSS responsive to receipt of a relocation request at the target SGSN.

The handover request received at the target BSS may include an exchange identification command indicator.

The mobile communication system may further include means, responsive to the exchange identification command indicator being set, for determining the accepted packet flow contexts.

The means for determining the accepted packet flow contexts may include means for allocating resources to one or more packet flow contexts downloaded from the target SGSN.

The target BSS may further include means, responsive to the means for determining the accepted packet flow contexts, for allocating a transport block flow for each transport flow context.

The means for notification of the accepted packet flow contexts may include means for identifying those packet flow contexts setup, and/or those packet flow contexts which have failed to be setup.

The invention provides a base station subsystem, BSS, adapted for packet switched handover in GERAN A/Gb mode, comprising: means for receiving a handover request; means for determining accepted packet flow contexts; means for notifying the accepted packet flow contexts.

The BSS may further comprise: means for receiving an exchange identification command for the accepted packet flow contexts: and means for transmitting a handover request response, said response including the exchange identification command for the setup flow control contexts.

The received handover request may include an exchange identification command indicator. The BSS may include means, responsive to the exchange identification command indicator being set, for determining the accepted packet flow contexts.

The means for determining the accepted packet flow contexts may include means for allocating resources to one or more packet flow contexts downloaded from a target SGSN.

The means for notification of the accepted packet flow contexts may include means for identifying those packet flow contexts setup, and/or those packet flow contexts which have failed to be setup.

The invention provides a serving GPRS support node, SGSN, adapted for packet switched handover in GERAN A/Gb mode, comprising: means for transmitting a handover requet; means for receiving notification of accepted packet flow contexts; means for transmitting an exchange identification command for the accepted packet flow contexts: and means for receiving a handover request response, said response including the exchange identification command for the setup flow control contexts.

The handover request may include an exchange identification command indicator.

The invention provides a mobile communication system adapted for packet switched handover in GERAN A/Gb mode, the system including a target base station subsystem, BSS, and a target serving GPRS support node, SGSN, the system further including: means, responsive to receipt of a relocation request at the target SGSN, for transmitting a request for packet flow contexts to a target base station subsystem, BSS; means for determining, at the target BSS, accepted packet flow contexts; means for transmitting details of the accepted packet flow contexts to the target SGSN; means for transmitting a handover request, including an exchange identification command for the accepted packet flow contexts, to the target BSS: and means for transmitting a handover request response to the target SGSN, said response including the exchange identification command for the setup flow control contexts.

The relocation request may comprise a forward relocation request message.

The means for transmitting a request for packet flow contexts to the target BSS may include means for initiating a BSS PFC create procedure at the target BSS.

The means for transmitting a request for packet flow contexts to the target BSS may include an indicator that the BSS PFC is subject to handover. The indicator may be included in an information element.

The mobile communication system may comprise means for reserving radio resources for one or more packet flow contexts downloaded from the target SGSN.

The mobile communication system may comprise means for allocating, at the target BSS, transport block flows for each accommodated packet flow context. The mobile communication system may further include means for creating a corresponding BSS PFC.

The means for transmitting details of the accepted packet flow contexts from the target BSS to the target SGSN may include means for transmitting a create BSS PFC Ack/NAck message.

The handover request may include an exchange identification command only for the accepted packet flow contexts. The handover request response may include the exchange identification command only for the setup flow control contexts. The invention provides a base station subsystem, BSS, adapted for packet switched handover in GERAN A/Gb mode, comprising: means for receiving a request for packet flow contexts; means for determining accepted packet flow contexts; means for transmitting details of the accepted packet flow contexts.

The BSS may further include: means for receiving a handover request, including an exchange identification command for the accepted packet flow contexts: and means for transmitting a handover request response, said response including the exchange identification command for the setup flow control contexts.

The relocation request may comprise a forward relocation request message.

The BSS may further comprise means for reserving radio resources for one or more packet flow contexts downloaded from a target SGSN.

The BSS may further comprise means for allocating transport block flows for each accommodated packet flow context.

The BSS may further include means for creating a corresponding BSS PFC.

The means for transmitting details of the accepted packet flow contexts may include means for transmitting a create BSS PFC Ack/NAck message.

The handover request may include an exchange identification command only for the accepted packet flow contexts. The handover request response may include the exchange identification command only for the setup flow control contexts.

The invention provides a serving GPRS support node, SGSN, adapted for packet switched handover in GERAN A/Gb mode, comprising: means, responsive to receipt of a relocation request at the SGSN, for transmitting a request for packet flow contexts to a base station subsystem, BSS; means for receiving details of the accepted packet flow contexts; means for transmitting a handover request, including an exchange identification command for the accepted packet flow contexts, to the BSS: and means for receiving a handover request response, said response including the exchange identification command for the setup flow control contexts.

The relocation request may comprise a forward relocation request message.

The means for transmitting a request for packet flow contexts to the target BSS may include means for initiating a BSS PFC create procedure at the target BSS.

The means for transmitting a request for packet flow contexts to the target BSS may include an indicator that the BSS PFC is subject to handover. The indicator may be included in an information element.

The handover request may include an exchange identification command only for the accepted packet flow contexts.

The handover request response may include the exchange identification command only for the setup flow control contexts.

The invention provides a message comprising a request for packet flow contexts for transmission between a serving GPRS support node, SGSN, and a base station subsystem, BSS, during a packet switched handover procedure in a GERAN A/Gb mode of operation, said message including an information element indicating that any BSS packet flow context established is subject to handover.

The invention provides a mobile communication system of packet switched handover in GERAN A/Gb mode, the handover comprising: means for transmitting an exchange identification command to a mobile station for any created packet flow context prior to connection of the mobile station in a target cell.

### BRIEF DESCRIPTION OF THE FIGURES

The invention will now be described by way of example with reference to the accompanying figures, in which:

FIG. 1 illustrates the known reference architecture for a packet switched handover in GERAN A/Gb mode;

FIG. 2 illustrates the known signalling in the packet switched handover preparation phase;

FIG. 3 illustrates signalling messages in accordance with one embodiment of the invention; and

FIG. 4 illustrates signalling messages in accordance with another embodiment of the invention.

### DESCRIPTION OF THE PREFERRED EMBODIMENTS

The invention is described herein by way of reference to particular example scenarios. In particular the invention is described in a general context in relation to a GSM/EDGE radio access network (GERAN).

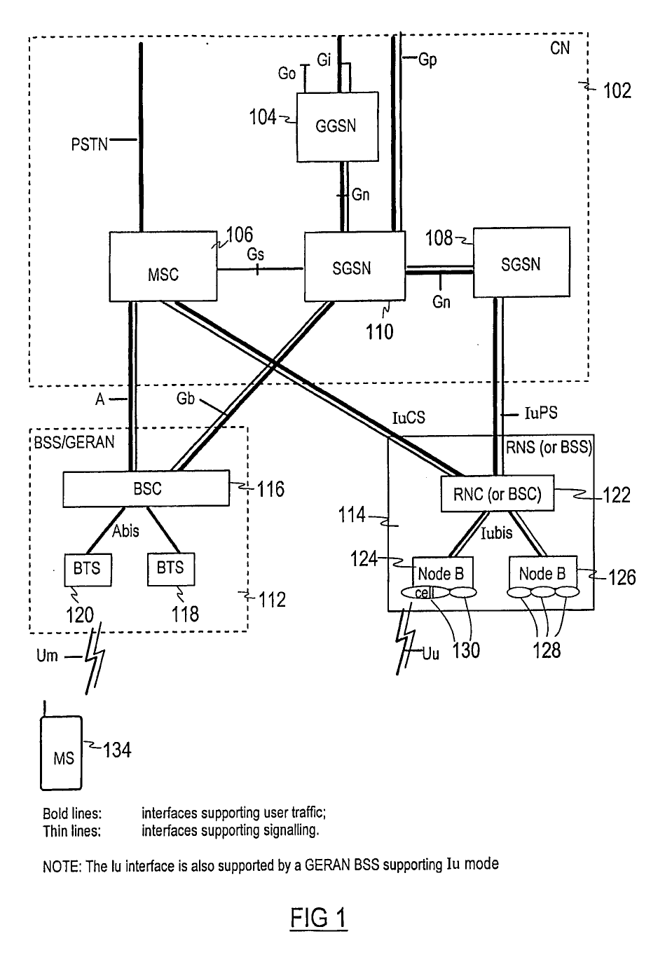

Referring to FIG. 1 there is illustrated the reference architecture for PS (packet switched) handover. In GERAN A/Gb mode, as presented in 3GPP TS 43.129 VO.6.0.

A core network (CN) 102 includes a gateway GPRS support node (GGSN) 104, a mobile switching centre (MSC), a serving GPRS support node (SGSN) 110, and a SGSN 108. A BSS (base station subsystem)/GERAN 112 includes a base station controller 116, and a plurality of base transceiver stations, such as the two BTSs 118 and 120. A radio network subsystem (RNS) or base station subsystem (BSS) 114 includes a radio network controller (RNS) or base station controller (BSC) 122, and a plurality of Node Bs such as the two Node Bs 128 and 130. A mobile station (MS) 134 is an example of one of possibly many mobile stations which may connect to the core network 102 via the BSS/GERAN 112 or the RNS or BSS 114.

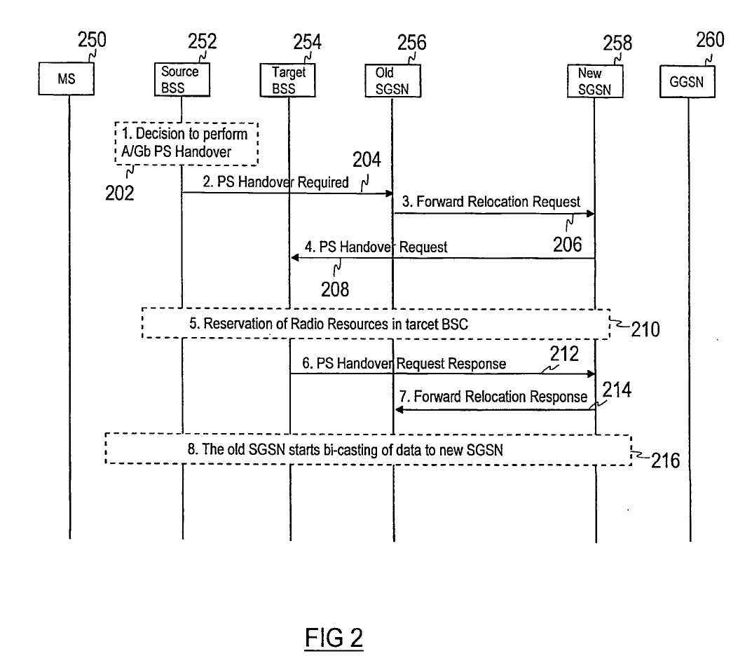

The architecture of FIG. 1 is known in the art, and is only those aspects of the architecture are discussed in detail herein as are necessary to understand implementations of the invention and embodiments thereof. 3GPP TS 43.129 VO.6.0 defines the PS handover preparation phase, which is described further herein with reference to FIG. 2 for the inter-SGSN case in order to assist in understanding the context of the present invention. It should be noted that the following description relates to a GERAN (A/Gb) to GERAN (A/Gb) handover for an inter-SGSN handover.

Referring to FIG. 2, as denoted by block 202 a source BSS 252 decides to initiate a packet switched (PS) handover. The basis for such an initiation is outside the scope of this invention, and known to one skilled in the art. Prior to the PS handover, at this stage, both the uplink and the downlink user data is transmitted via the following mechanisms: temporary block flows (TBFs) between a mobile station (MS) 250 and the source base station subsystem (BSS) 252; base station subsystem GPRS protocol (BSSGP) packet flow contexts (PFCs) tunnel(s) between the source BSS 252 and an old SGSN 256; and GPRS tunnelling protocol (GTP) tunnel(s) between an old SGSN 256 and the GGSN 260.

It should be noted that in this discussion the ‘old’ SGSN refers to an SGSN from which a connection is to be removed, and a ‘new’ SGSN refers to an SGSN to which a connection is to be moved, all as a result of the PS handover.

The source BSS 252 then sends a ‘PS Handover Required’ message 204 to the old SGSN 256. This message contains: the old TLLI; Cause; Source Cell Identifier; Target Cell Identifier; and source BSS to target BSS transparent container, as is known in the art. The source BSS to target BSS transparent container includes BSS specific information for PS Handover co-ordination. The old SGSN 256 determines from the Target Cell Identifier whether the PS Handover is of an intra- or inter-SGSN type. In the present case, the PS handover is of the inter-SGSN type.

In the case of inter-SGSN PS Handover, the old SGSN 256 then initiates the PS Handover resource allocation procedure by sending a ‘Forward Relocation Request’ message 206 to a new SGSN 258. This message contains: IMSI; Cause; Source Cell Identifier; Target Cell Identifier; MM Context; PDP Contexts; Packet Flow ID; SNDCP XID parameters (FFS); LLC XID parameters (FFS); MS Radio Access Capabilities; Tunnel Endpoint Identifier Control Plane; SGSN Address; Source BSS to target BSS transparent container; and PDP Context Prioritisation, as is known in the art. From the PDP Contexts the service access point identifiers (SAPIs) and the NSAPIs to be used in the new SGSN 258 may be extracted at the new SGSN 258.

The new SGSN 258 then sends a ‘PS Handover Request’ message 208 to a target BSS 254. This message contains: Local TLLI; Cause; IMSI; Source Cell Identifier; Target Cell Identifier; MS Radio Access Capabilities; Source BSS to target BSS transparent container; and the PFCs To Be Set Up List, as is known in the art. The packet flow contexts (PFCs) required to be set up are downloaded to the target BSS 254 from the new SGSN 258, i.e. all the information required for PFC creation is downloaded from the new SGSN 258 to the target BSS 254.

The target BSS 254 establishes an MS context, sets up the PFCs as indicated, and reserves radio resources for one or more of the PFCs downloaded from the new SGSN as denoted by functional block 210. Due to resource limitations, however, not all downloaded PFCs may receive resource allocation. The target BSS 254 allocates TBFs for each PFC subject to PS handover that can be accommodated by the target BSS 254.

After all necessary resources for the accepted PFCs are successfully allocated, the target BSS 254 sends a ‘PS Handover Request Response’ message 212 to the new SGSN 258. This message includes: Local TLLI; Cause; PFCs Setup/Failed to Setup; and Target BSS to source BSS transparent container (including configuration of resources in target cell), as is known in the art. If the quality of service (QoS) parameters for any of the indicated PFCs are not accepted by the target BSS 254, the target BSS 254 indicates ‘PFCs Failed to setup’ in the message 212. After sending the ‘PS Handover Request Response’ message 212, the target BSS 254 is ready to receive the downlink LLC PDUs from the new SGSN 258.

It can thus be seen that during the PS handover procedure the uplink/downlink data transfer can continue only for the PFCs setup.

When the new SGSN 258 receives the ‘PS Handover Request Response’ message 212, a ‘Forward Relocation Response’ message 214 is sent from the new SGSN 258 to the old SGSN 256. This message 214 includes: IMSI; Cause; NSAPI(s); Target BSS to Source BSS transparent container; Tunnel Endpoint Identifier Control Plane; SGSN Address; and Tunnel Endpoint Identifier Data II, as is known in the art. This message indicates that the new SGSN 258 is ready to receive packets forwarded from the old SGSN 256. If either the target BSS 254 or the new SGSN 258 failed to allocate resources, then this is indicated in the message 212.

When the old SGSN 256 receives the ‘Forward Relocation Response’ message 214, it decides whether to proceed with the handover. The preparation phase is then finished and the execution phase follows if the handover is proceed with. As denoted by functional block 216, if the handover is proceeded with the old SGSN 256 commences bi-casting of data to the new SGSN 258.

This invention provides, in embodiments, mechanisms for transferring an exchange identification (XiD) command between the new SGSN 258 in the target cell and the target BSS 254 only for the BSS PFCs which are accepted during the PS handover preparation phase. As well as transferring this command between the new or target SGSN 258 and the new or target BSS 254, it is proposed in embodiments that the target BSS 254 sends this command further to the MS 250 in the source cell.

The new SGSN 258 may, for example, create an XiD command before sending the ‘PS Handover Request’ message 208, or upon receiving the ‘PS Handover Request Response’ message 212. However as described above the new SGSN 258 will know the ‘Setup PFCs’ and the ‘Failed to Setup PFC’ only upon receiving the ‘PS Handover Request Response’ message 212. As the data transfer during the PS handover procedure may continue only for the ‘Setup PFCs’, the MS 250 only need receive, in the PS Handover Command, the XiD command related to these PFCs, and not the XiD Commands for all the PFCs.

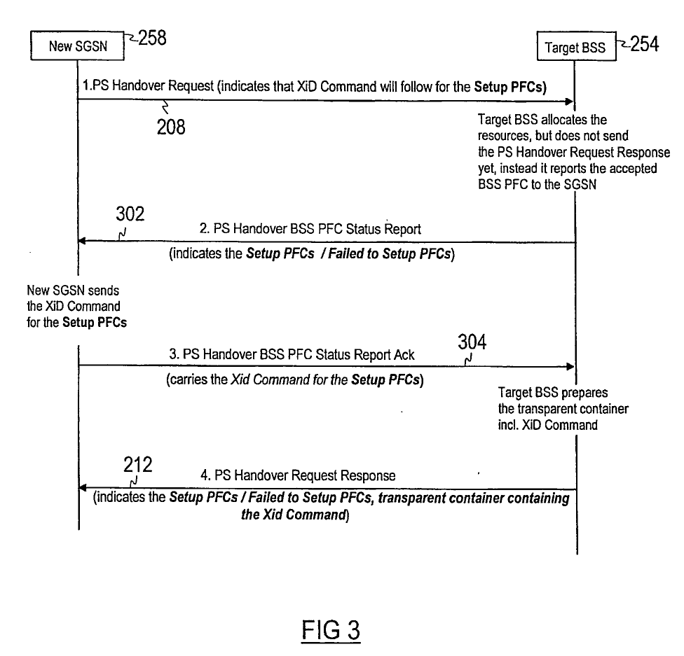

In order to enable sending of the XiD Command only for the ‘Setup PFCs’ in the target cell, a new solution is provided by the invention. A first embodiment of this solution is described with reference to FIG. 3. Where like elements are described, FIG. 3 uses reference numerals used in FIG. 2.

As depicted in FIG. 3 there are two new messages proposed compared to the signalling in 3GPP TS 43.129 VO.6.0 needed on the Gb interface between the new SGSN and the target BSS for the XiD command transfer.

The signalling flow depicted in FIG. 3 is described below:

The new SGSN 258, upon receiving the ‘Forward Relocation Request’ message 206, sends a ‘PS Handover Request’ message 208 to the target BSS 254. With respect to FIG. 2 above, this message is modified to further include an XiD Command Indicator. If the XiD Command Indicator is set, then the target BSS 254 receiving this message 208 is required to send a ‘BSS PFC setup status report’ which indicates the ‘Setup PFCs’/‘Failed to Setup PFCs’ to the new SGSN 258 prior to the ‘PS Handover Request Response’ message 212. If the XiD Command Indicator is not set than the target BSS 254 sends the ‘PS Handover Request Response’ message 212 without first sending the ‘BSS PFC setup status report’ to the new SGSN.

The target BSS 254 establishes an MS BSS PFC context, sets up the PFCs as indicated, and reserves radio resources for one or more of the PFCs downloaded from the new SGSN, as discussed in relation to the functional block 210 of FIG. 2. As further discussed in relation to FIG. 2, due to resource limitations not all downloaded PFCs will necessarily receive resource allocation. The target BSS 254 allocates TBFs for each PFC subject to handover that can be accommodated by the target BSS, and sends a ‘PS Handover BSS PFC Status Report’ message 302 to the new SGSN 258 to indicate the ‘Setup PFCs’/‘Failed to Setup PFCs’.

The ‘PS Handover BSS PFC Status Report’ effectively provides an identification for those PFCs that can be accommodated.

The new SGSN 258, upon receiving the ‘PS Handover BSS PFC Status Report’ message 302, sends the XiD Command for each of the ‘Setup PFCs’ to the target BSS 254 in a ‘PS Handover BSS PFC Status Report Ack’ message 304.

The target BSS 254, after receiving all the necessary information for the accepted PFCs, sends the ‘PS Handover Request Response’ message to the new SGSN 258. The ‘PS Handover Request Response message 212 additionally includes the XiD Command. Upon sending the ‘PS Handover Request Acknowledge’ message 212, the target BSS 254 is ready to receive downlink LLC PDUs from the new SGSN 258.

The solution described above with reference to FIG. 3 offers one alternative for implementing the invention.

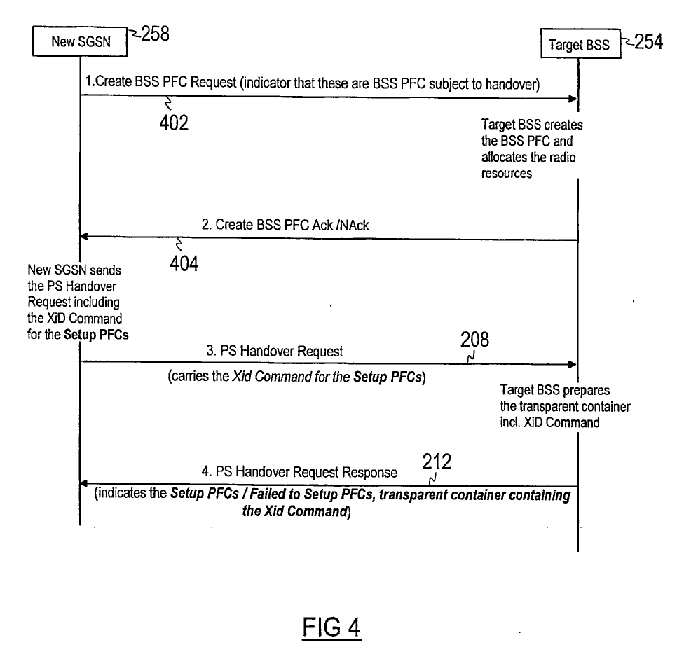

In addition to the solution described with reference to FIG. 3, a further solution in accordance with the principles of the invention may be provided, the principle being that the new SGSN sends the XiD Command to the target BSS only for the ‘Setup PFCs’. In this second solution, existing procedures may be utilised to achieve the same result, i.e. sending of the XiD Command in the transparent container to the MS for the ‘Setup PFCs’ only. This solution is described with reference to FIG. 4.

In this second solution the new SGSN 258, upon receiving the ‘Forward Relocation Request’ message 206 during Inter-SGSN PS Handover, initiates a ‘Create BSS PFC’ procedure to the target BSS 254 for all the active PDP contexts for which the new SGSN 258 decides to proceed with for the PS handover. This is achieved by sending a ‘Create BSS PFC’ message 402 from the new SGSN 258 to the target BSS 254. The message includes an indicator that the BSS PFC is subject to PS handover. The indicator is preferably a new Information Element which is added to the message, so that the target BSS 254 knows that there is to be a PS Handover Request following the BSSs response.

The target BSS 254 creates the BSS PFC contexts as defined in 3GPP TS 43.129 VO.6.0. Target BSS establishes an MS context, sets up the PFCs as indicated, and reserves radio resources for one or more of the PFCs downloaded from the new SGSN 258. As discussed above, due to resource limitations not all downloaded PFCs will necessarily receive resource allocation. The target BSS 254 allocates TBFs for each PFC subject to handover that can be accommodated by the target BSS 254, and creates a corresponding BSS PFC.

After creating the BSS PFC and allocating the appropriate radio resources, the target BSS 254 transmits a ‘Create BSS PFC Ack/NAck’ message 404 to the new SGSN 258.

The new SGSN 258, upon receiving the ‘Create BSS PFC Ack/NAck’ message 404 is provided with information on the status of the PFCs which are to be subject to handover, i.e. the ‘PFCs Setup’ and the ‘Failed to Setup PFC’. Based on the ‘Setup PFCs’ the new SGSN 258 sends to the target BSS 254 the ‘PS Handover Request’ message 208 adapted to carry the XiD Command for these PFCs only.

The target BSS 254, after receiving all the necessary information for the accepted FPCs, then sends the received command further as part of the transparent container in the ‘PS Handover Request Response’ message 212. This message is adapted to include the XiD Command.

After the ‘PS Handover Request Response’ message 212 the target BSS shall be prepared to receive downlink LLC PDUs from the new SGSN.

The invention, in its various embodiments, reduces the service interruption during PS handover by sending the XiD command to the mobile station prior to the cell change, i.e. before the MS moves into the target cell. In this way, by exchanging the XiD, the LLC and SNDCP parameters may be exchanged between the mobile station and the target SGSN during the preparation phase of the packet switched handover.

In the foregoing description it should be understood that reference to a new SGSN and a target SGSN are interchangeable, as are reference to a new BSS and a target BSS.

The invention is applicable to packet switched handover in GERAN A/Gb mode, and particularly to GERAN A/GB mode to GERAN A/Gb mode handover scenarios, and UTRAN/GERAN Iu mode to GERAN A/Gb mode handover scenarios.

The invention is applicable to intra-SGSN PS handover as well as inter-OSGSN handover. Teh solution is effectively the same regardless as to whether handover is intra or inter-SGSN. In the case of intra-SGSN handover, there is a single SGSN and the trigger for sending the PS handover request in the first described solution and the create BSS PFC request in the second described solution will be a PS handover required message instead of the forward relocation request message.

The invention has been described herein by way of reference to particular non-limiting examples. One skilled in the art will understand the general applicability of the invention. The scope of protection afforded by the invention is defined in the appended claims.

1. A method of packet switched handover in GERAN A/Gb mode, which method comprises transferring an exchange identification command between a target serving GPRS support node, SGSN, and a target base station subsystem, BSS, only for those packet flow contexts which are accepted during the packet switched handover preparation phase.

2. A method according to claim 1 further comprising determining at the target BSS resources for handover, which includes determining acceptance of packet flow contexts.

3. A method according to claim 1 wherein the packet flow contexts are accepted in dependence on the allocation of radio resources thereto.

4. A method according to claim 1 further comprising transferring said exchange identification command to a mobile station subject to the handover.

5. A method according to claim 1 wherein the exchange command is created before transmission of a handover request message.

6. A method according to claim 1 wherein the exchange command is created upon receipt of a handover request response message.

7. A method of packet switched handover in GERAN A/Gb mode, the method comprising:
[[a.]] receiving a handover request at a target base station subsystem, BSS;
[[b.]] determining, at the target BSS, accepted packet flow contexts;
[[c.]] notifying the accepted packet flow contexts to the target SGSN;
[[d.]] receiving an exchange identification command for the accepted packet flow contexts at the target BSS: and
[[e.]] receiving a handover request response at the target SGSN, said response including the exchange identification command for the setup flow control contexts.

8. A method according to claim 7 wherein the handover request is transmitted from the target SGSN to the target BSS responsive to receipt of a relocation request at the target SGSN.

9. A method according to claim 7 wherein the handover request received at the target BSS includes an exchange identification command indicator.

10. A method according to claim 9 wherein responsive to the exchange identification command indicator being set, the accepted packet flow contexts are determined.

11. A method according to claim 7 wherein determining the accepted packet flow contexts includes allocating resources to one or more packet flow contexts downloaded from the target SGSN.

12. A method according to claim 7 wherein responsive to determining the accepted packet flow contexts, the target BSS allocates a transport block flow for each transport flow context.

13. A method according to claim 7 wherein the notification of the accepted packet flow contexts includes the identity of those packet flow contexts setup, and/or those packet flow contexts which have failed to be setup.

14. A method according to any one of claims claim 7 wherein receiving the exchange identification command for the accepted packet flow contexts at the target BSS comprises including said command in a packet switched handover BSS PFC status report acknowledgement message at the target SGSN.

15. A method of packet switched handover in GERAN A/Gb mode, the method comprising:
[[a.]] responsive to receipt of a relocation request at a target SGSN, transmitting a request for packet flow contexts to a target base station subsystem, BSS;
[[b.]] determining, at the target BSS, accepted packet flow contexts;
[[c.]] transmitting details of the accepted packet flow contexts to the target SGSN;
[[d.]] transmitting a handover request, including an exchange identification command for the accepted packet flow contexts, to the target BSS: and [[e.]] transmitting a handover request response to the target SGSN, said response including the exchange identification command for the setup flow control contexts.

16. A method according to claim 15 wherein the relocation request comprises a forward relocation request message.

17. A method according to claim 15 wherein the step of transmitting a request for packet flow contexts to the target BSS includes initiating a BSS PFC create procedure at the target BSS.

18. A method according to claim 15 wherein the transmitting of a request for packet flow contexts to the target BSS includes an indicator that the BSS PFC is subject to handover.

19. A method according to claim 18 wherein the indicator is included in an information element.

20. A method according to claim 15 comprising reserving radio resources for one or more packet flow contexts downloaded from the target SGSN.

21. A method according to claim 15 wherein the method comprises allocating, at the target BSS, transport block flows for each accommodated packet flow context.

22. A method according to claim 21 further creating a corresponding BSS PFC.

23. A method according to claim 15 wherein the transmitting of details of the accepted packet flow contexts from the target BSS to the target SGSN includes transmitting a create BSS PFC Ack/NAck message.

24. A method according to claim 15 wherein the handover request includes an exchange identification command only for the accepted packet flow contexts.

25. A method according to claim 15 wherein the handover request response includes the exchange identification command only for the setup flow control contexts.

26. A method of packet switched handover in GERAN A/Gb mode, the method comprising: transmitting an exchange identification command to a mobile station for any created packet flow context prior to connection of the mobile station in a target cell.

27. A mobile communication system adapted for packet switched handover in GERAN A/Gb mode, said system comprising, during handover, a target serving GPRS support node, SGSN, and a target base station subsystem, BSS, in which system the transfer of an exchange identification command between the target SGSN and the BSS is only for those packet flow contexts which are accepted during the packet switched handover preparation phase.

28. A mobile communication system according to claim 27 wherein the target BSS is adapted to determine resources for handover, in dependence on which the acceptance of packet flow contexts is determined.

29. A mobile communication system according to claim 27 wherein the packet flow contexts are accepted in dependence on the allocation of radio resources thereto.

30. A mobile communication system according to claim 27 further wherein said exchange identification command is transferred to a mobile station subject to the handover.

31. A mobile communication system according to claim 27 wherein the exchange command is created before transmission of a handover request message.

32. A mobile communication system according to claim 27 wherein the exchange command is created upon receipt of a handover request response message.

33. A mobile communication system adapted for packet switched handover in GERAN A/Gb mode, the system including a target base station subsystem, BSS, and a target serving GPRS support node, SGSN, the system further including: means for receiving a handover request at the target BSS; means for determining, at the target BSS, accepted packet flow contexts; means for notifying the accepted packet flow contexts to the target SGSN; means for receiving an exchange identification command for the accepted packet flow contexts at the target BSS: and means for receiving a handover request response at the target SGSN, said response including the exchange identification command for the setup flow control contexts.

34. A mobile communication system according to claim 33 further including means for transmitting the handover request from the target SGSN to the target BSS responsive to receipt of a relocation request at the target SGSN.

35. A mobile communication system according to claim 33 wherein the handover request received at the target BSS includes an exchange identification command indicator.

36. A mobile communication system according to claim 35 further including means, responsive to the exchange identification command indicator being set, for determining the accepted packet flow contexts.

37. A mobile communication system according to claim 33 wherein the means for determining the accepted packet flow contexts includes means for allocating resources to one or more packet flow contexts downloaded from the target SGSN.

38. A mobile communication system according to claim 33 wherein the target BSS further includes means, responsive to the means for determining the accepted packet flow contexts, for allocating a transport block flow for each transport flow context.

39. A mobile communication system according to claim 33 wherein the means for notification of the accepted packet flow contexts includes means for identifying those packet flow contexts setup, and/or those packet flow contexts which have failed to be setup.

40. A base station subsystem, BSS, adapted for packet switched handover in GERAN A/Gb mode, comprising: means for receiving a handover request; means for determining accepted packet flow contexts; and means for notifying the accepted packet flow contexts.

41. A BSS according to claim 40 further comprising: means for receiving an exchange identification command for the accepted packet flow contexts: and means for transmitting a handover request response, said response including the exchange identification command for the setup flow control contexts.

42. A BSS according to claim 40 wherein the received handover request includes an exchange identification command indicator.

43. A BSS according to claim 42 further including means, responsive to the exchange identification command indicator being set, for determining the accepted packet flow contexts.

44. A BSS according to claim 40 wherein the means for determining the accepted packet flow contexts includes means for allocating resources to one or more packet flow contexts downloaded from a target SGSN.

45. A BSS according to claim 40 wherein the means for notification of the accepted packet flow contexts includes means for identifying those packet flow contexts setup, and/or those packet flow contexts which have failed to be setup.

46. A serving GPRS support node, SGSN, adapted for packet switched handover in GERAN A/Gb mode, comprising: means for transmitting a handover request; means for receiving notification of accepted packet flow contexts; means for transmitting an exchange identification command for the accepted packet flow contexts: and means for receiving a handover request response, said response including the exchange identification command for the setup flow control contexts.

47. A SGSN according to claim 46 wherein the handover request includes an exchange identification command indicator.

48. A mobile communication system adapted for packet switched handover in GERAN A/Gb mode, the system including a target base station subsystem, BSS, and a target serving GPRS support node, SGSN, the system further including: means, responsive to receipt of a relocation request at the target SGSN, for transmitting a request for packet flow contexts to a target base station subsystem, BSS; means for determining, at the target BSS, accepted packet flow contexts; means for transmitting details of the accepted packet flow contexts to the target SGSN; means for transmitting a handover request, including an exchange identification command for the accepted packet flow contexts, to the target BSS: and means for transmitting a handover request response to the target SGSN, said response including the exchange identification command for the setup flow control contexts.

49. A mobile communication system according to claim 48 wherein the relocation request comprises a forward relocation request message.

50. A mobile communication system according to claim 48 wherein the means for transmitting a request for packet flow contexts to the target BSS includes means for initiating a BSS PFC create procedure at the target BSS.

51. A mobile communication system according to claim 48 wherein the means for transmitting a request for packet flow contexts to the target BSS includes an indicator that the BSS PFC is subject to handover.

52. A mobile communication system according to claim 51 wherein the indicator is included in an information element.

53. A mobile communication system according to claim 48 comprising means for reserving radio resources for one or more packet flow contexts downloaded from the target SGSN.

54. A mobile communication system according to claim 48 further comprising means for allocating, at the target BSS, transport block flows for each accommodated packet flow context.

55. A mobile communication system according to claim 54 further including means for creating a corresponding BSS PFC.

56. A mobile communication system according to claim 48 wherein the means for transmitting details of the accepted packet flow contexts from the target BSS to the target SGSN includes means for transmitting a create BSS PFC Ack/NAck message.

57. A mobile communication system according to claim 48 wherein the handover request includes an exchange identification command only for the accepted packet flow contexts.

58. A mobile communication system according to claim 48 wherein the handover request response includes the exchange identification command only for the setup flow control contexts.

59. A base station subsystem, BSS, adapted for packet switched handover in GERAN A/Gb mode, comprising: means for receiving a request for packet flow contexts; means for determining accepted packet flow contexts; and means for transmitting details of the accepted packet flow contexts.

60. A BSS according to claim 59 further including: means for receiving a handover request, including an exchange identification command for the accepted packet flow contexts: and means for transmitting a handover request response, said response including the exchange identification command for the setup flow control contexts.

61. A BSS according to claim 59 wherein the relocation request comprises a forward relocation request message.

62. A BSS according to claim 59 further comprising means for reserving radio resources for one or more packet flow contexts downloaded from a target SGSN.

63. A BSS according to claim 59 further comprising means for allocating transport block flows for each accommodated packet flow context.

64. A BSS according to claim 63 further including means for creating a corresponding BSS PFC.

65. A BSS according to claim 59 wherein the means for transmitting details of the accepted packet flow contexts includes means for transmitting a create BSS PFC Ack/NAck message.

66. A BSS according to claim 59 wherein the handover request includes an exchange identification command only for the accepted packet flow contexts.

67. A BSS according to claim 59 wherein the handover request response includes the exchange identification command only for the setup flow control contexts.

68. A serving GPRS support node, SGSN, adapted for packet switched handover in GERAN A/Gb mode, comprising: means, responsive to receipt of a relocation request at the SGSN, for transmitting a request for packet flow contexts to a base station subsystem, BSS; means for receiving details of the accepted packet flow contexts; means for transmitting a handover request, including an exchange identification command for the accepted packet flow contexts, to the BSS: and means for receiving a handover request response, said response including the exchange identification command for the setup flow control contexts.

69. A SGSN according to claim 68 wherein the relocation request comprises a forward relocation request message.

70. A SGSN according to claim 68 wherein the means for transmitting a request for packet flow contexts to the target BSS includes means for initiating a BSS PFC create procedure at the target BSS.

71. A SGSN according to claim 68 wherein the means for transmitting a request for packet flow contexts to the target BSS includes an indicator that the BSS PFC is subject to handover.

72. A SGSN according to claim 71 wherein the indicator is included in an information element.

73. A SGSN according to claim 68 wherein the handover request includes an exchange identification command only for the accepted packet flow contexts.

74. A SGSN according to claim 68 wherein the handover request response includes the exchange identification command only for the setup flow control contexts.

75. A message comprising a request for packet flow contexts for transmission between a serving GPRS support node, SGSN, and a base station subsystem, BSS, during a packet switched handover procedure in a GERAN A/Gb mode of operation, said message including an information element indicating that any BSS packet flow context established is subject to handover.

76. A mobile communication system of packet switched handover in GERAN A/Gb mode, the system comprising: means for transmitting an exchange identification command to a mobile station for any created packet flow context prior to connection of the mobile station in a target cell.
